(19) United States
(12) Patent Application Publication
(10) Pub. No.: US 2003/0104891 A1
(43) Pub. Date: Jun. 5, 2003

(54) Silent chain

(76) Inventors: Toyonaga Saitoh, Osaka (JP); Nobuto Kozakura, Osaka (JP)

Correspondence Address: HOWSON AND HOWSON, ONE SPRING HOUSE CORPORATION CENTER, BOX 457, 321 NORRISTOWN ROAD, SPRING HOUSE, PA, 19477, US

(21) Appl. No.: 10/290,893

(22) Filed: Nov. 8, 2002

(30) Foreign Application Priority Data
Nov. 30, 2001 (JP) 366993/2001

(51) Int. Cl. F16H 7/06; F16G 13/04

(52) U.S. Cl. 474/212; 474/213; 474/157

(57) ABSTRACT

In a silent chain, the inner, toothed, plates and the outer guide plates are formed so that, when the centers of the holes for receiving connecting pins are disposed on a straight pitch line, the back surfaces of the guide plate are lower than the back surfaces of the inner plates by at least ½ of the difference between the inner diameters of the pin holes of the inner plates and the outer diameter of the connecting pins. As a result, the backs of the guide plates are either in flush relationship with, or below the backs of the inner plates. Pressure exerted by a guide on the back of the chain is distributed uniformly over a large area, and concentrated loads on the guide plates, which can cause dislodgment of the pins from the pin holes in the guide plates are avoided.

### FIELD OF THE INVENTION

This invention relates silent chains, which are used in the transmission of power in automobile engines, general purpose engines, industrial machines and the like. The invention relates more specifically to a silent chain which, in use, is in sliding contact with a guide.

### BACKGROUND OF THE INVENTION

A typical use of a silent chain is in the timing mechanism of an automobile engine, where the chain transmits power from the engine's crankshaft to one or more valve-operating camshafts, as shown in FIG. 4. The timing mechanism comprises a crankshaft sprocket 2, camshaft sprockets 3, an endless silent chain 4 disposed in a loop extending around sprockets 2 and 3, a guide 5 engaged with the chain on one side of the loop, a tensioner 6, and a tensioner lever 7 engaged with the chain on the opposite side of the loop.

The guide 5 prevents overtensioning or overloosening of the silent chain 4 both during assembly and during operation, and also prevents vibration, both in the plane of travel of the chain, and in directions transverse to that plane. The tensioner lever 7 also serves as a guide, and is pressed against the chain 4 by the tensioner 6, in order to apply appropriate tension to the chain while in sliding contact therewith. The tensioner lever also serves to prevent vibration of the chain, both in the plane of chain travel and in directions transverse to that plane.

As shown in FIGS. 6A and 6B, the silent chain 4 comprises guide plates 8, each having a pair of pin holes 8a, inner plates 9, each having a pair of pin holes 9a and a pair of teeth 9b for meshing with sprockets of a transmission, and connecting pins 10. The chain is formed by combining the inner plates 9 and the guide plates 8 in an interleaved configuration, and connecting them by means of connecting pins 10, in such a way that the positions of adjacent plates are shifted relative to each other in the longitudinal direction of the chain.

In this case, the connecting pin 10 is tightly fitted in, and secured to, pin holes 8a of guide plates 8, which are the outermost plates of the chain, and extends though pin holes 9a of the toothed inner plates 9 with a clearance.

A conventional silent chain 4 is formed, as shown in FIGS. 6(A) and 6(B), so that, when the chain is stretched and in a straight condition, and a pitch line 11 extends through the centers of the respective pin holes 8a of the guide plate 8, and 9a of the inner plate 9, the back surfaces 8c of the guide plates 8 and the back surfaces 9c of the inner plates 9 are flush with one another other, and entire back surface of the chain is constituted by plate surfaces that are in flush relationship with adjacent plate surfaces. Thus, as shown in FIG. 6(A), if the distance between the back surface 8c of a guide plate 8 and the pitch line 11 is K1, and the distance between the back surface 9c of an inner plate 9 and the pitch line is K2, the relation K1=K2 is satisfied.

Referring to FIG. 8(B), since the connecting pin 10 fits into the pin holes 9a of the inner plates 9 with a clearance, a gap exists between an inner diameter M1 of the pin hole 9a and an outer diameter M2 of the connecting pin 10. The maximum width M of the gap satisfies the relationship M M1−M2.

When the chain 4 is moving while being pressed and guided by a tensioner lever such as lever 7 in FIG. 4, if the pin holes 8a of the guide plates 8 are tightly fitted and secured to the connecting pin 10 while the pin holes 9a of the inner plate 9 are fitted into the connecting pin 10 with a clearance which can be as large as M, the inner plates are free to move inward (toward the interior of the loop formed by the chain) as shown in FIGS. 7(A) and 7(B). When the inner plates move inward, the back surfaces 9c of the inner plates 9 are no longer flush with the back surfaces 8c of the guide plate 8 in FIG. 7(A), and value K of the difference between the levels of the back surfaces 8c and 9c is one-half the maximum value M of the gap between the pin 10 and the holes 9a, that is the difference between the inner diameter M1 of the pin hole 9a and the outer diameter M2 of the connecting pin 10 can be expressed by the relationship K=(1/2) M.

As a result, when the tensioner lever 7 is urged by the tensioner 6 into contact with the chain, only the back surfaces 8c of the guide plates 8 come into contact with the tensioner lever, and the pressure of the tensioner lever is exerted only on the guide plates. The concentration of load results in accelerated wear at opposite edges of the shoe 7a (FIG. 5) of the tensioner lever 7, and in increased frictional heating. Moreover, since the load is applied only to the portions of the guide plates between the pin holes 8a and the connecting pin 10, where the pin is secured to the guide plates, the force holding the pin and guide plates together tends to decrease, and the connecting pin 10 may become dislodged with a resultant breakage of the chain.

As described above, if a difference K exists between the level of the back surfaces 9c of the inner plates 9 and the level of the back surfaces 8c of the guide plates 8, a gap K′, corresponding to the level difference K, is formed between the shoe 7a of the tensioner lever 7 and the back surfaces 9c of the inner plates 9, as shown in FIG. 5. Because of the level difference K, the back surfaces 9c are not pressed by the tensioner lever 7. Moreover, the guide plates 8 contact the tensioner lever 7 only at intervals spaced from one another by the pitch distance of the chain, causing the effective height of the back surface to vary along the length of the chain. Since the back surface of the chain travels in sliding contact with a tensioner lever 7, the height variation of the back surface tends to cause the movement of the chain to become unstable. The same problems exist where the chain is in sliding contact with a guide 5.

Accordingly, an object of the invention is to solve the above-mentioned prior art problems. It is also an object of the invention to provide a silent chain in which wear at the opposite edge portions of a guide member is suppressed, and surface pressure is exerted by the guide member over the entire width of the back surface of the chain rather than only on the back surfaces of the guide plates. Still another object of the invention is to prevent breakage of the chain due to loosening of the fit between the pin holes of the guide plates and the connecting pins as a result of concentration of forces. A further object of the invention is to provide a silent chain, which is capable of smoothly advancing over a guide member, by removing the difference between the level of back surfaces of the inner plates and the back surfaces of the guide plates.

### SUMMARY OF THE INVENTION

The silent chain according to this invention comprises a guide plate having a back surface and a pair of pin holes, a connecting pin, having an outer diameter, fitted into and secured to one of said pin holes, and a toothed plate having teeth for meshing engagement with a sprocket and also having a back surface and a pair of pin holes each having an inner diameter, the connecting pin fitting into one of the pin holes of the toothed plate with a clearance, wherein, when said guide plate and said toothed plate are arranged so that a pitch line extending through the centers of their respective pin holes is straight, the back surface of said guide plate is closer than the back surface of said toothed plate to the pitch line by at least 1/2 of the difference between the inner diameter of said one of the pin holes of the toothed plate and the outer diameter of said connecting pin.

In most silent chains, the construction will be such that a plurality of toothed plates will be disposed as inner plates in a row extending widthwise of the chain between a pair of guide plates, and the inner plates between the guide plates will be in intermeshing relationship with an adjacent row of toothed plates. When the back surfaces of the guide plates are closer than the back surfaces of the toothed plates to the pitch line by 1/2 of the difference between the diameter of said one of the pin holes of the toothed plate and the outer diameter of the connecting pin, the back surfaces of the guide plates become flush with the back surfaces of the toothed plates, so that the entire back surface of the chain becomes flush. Alternatively, when the back surfaces of the guide plates are closer than the back surfaces of the toothed plates to the pitch line by more than 1/2 of the difference between the diameter of said one of the pin holes of the toothed plate and the outer diameter of the connecting pin, the back surface of the inner plates are flush with one another but extend outward beyond the back surfaces of the guide plates.

When the entire back surfaces of the silent chain, or at least the back surfaces of the toothed inner plates, become flush with one another, the pressure between the back surface of the guide plates and the guide member is reduced. Accordingly, the force exerted by the guide member on the guide plates is reduced and has a less deleterious effect on the engagement of the connecting pin with the holes in the guide plates. Accordingly, the likelihood of breakage of the chain due to disengagement of a connecting pin from a guide plate is significantly reduced.

Furthermore, when the entire back surfaces of the silent chain or at least the back surfaces of the inner plates, become flush with one another so that they are all at the same level when they come into contact with a guide, the silent chain travels more smoothly over the guide.

### BRIEF DESCRIPTION OF THE DRAWINGS

FIG. 1(A) is a side elevational view of a part of a silent chain in accordance with a first embodiment of the invention;

FIG. 1(B) is a cross-sectional view taken on plane X-X′ of FIG. 1(A);

FIG. 2(A) is a side elevational view showing the same part of the chain as shown in FIGS. 1(A) and 1(B), when in engagement with a guide;

FIG. 2(B) is a cross-sectional view taken on plane X-X′ in FIG. 2(A);

FIG. 2(C) is a top plan view of the chain of FIGS. 2(A) and 2(B), showing the parts thereof that come into contact with the chain-contacting surface of a guide;

FIG. 3(A) is a side elevational view of a part of a silent chain in accordance with a second embodiment of the invention;

FIG. 3(B) is a cross-sectional view taken on plane X-X′ in FIG. 3(A);

FIG. 3(C) is a top plan view of the chain of FIGS. 3(A) and 3(B), showing the parts thereof that come into contact with the chain-contacting surface of a guide;

FIG. 4 is an elevational view of a conventional timing transmission mechanism of an engine, using a silent chain;

FIG. 5 is an enlarged view of a portion F in FIG. 4, illustrating the manner in which a conventional silent chain contacts a chain guide;

FIG. 6(A) is a side elevational view of a part of a conventional silent chain;

FIG. 6(B) is a cross-sectional view taken on plane Y-Y′ in FIG. 6(A);

FIG. 7(A) is a side elevational view showing the same part of the conventional silent chain shown in FIGS. 6(A) and 6(B), when in engagement with a guide;

FIG. 7(B) is a cross-sectional view taken on plane Y-Y′ in FIG. 7(A); and

FIG. 7(C) is a top plan view of the chain of FIGS. 7(A) and 7(B), showing the parts thereof that come into contact with the chain-contacting surface of a guide.

### DETAILED DESCRIPTION OF THE PREFERRED EMBODIMENTS

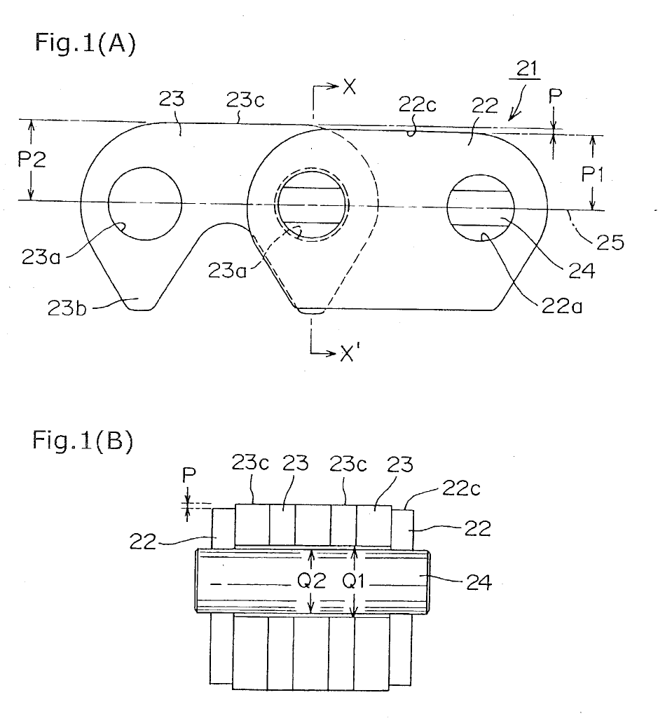

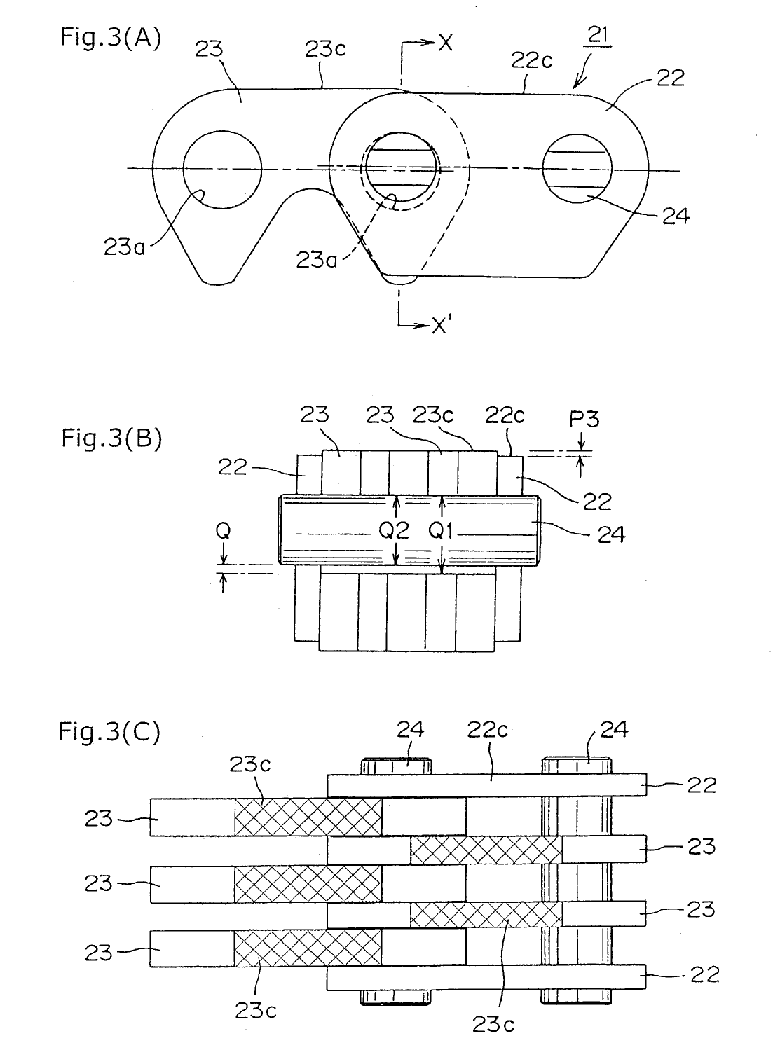

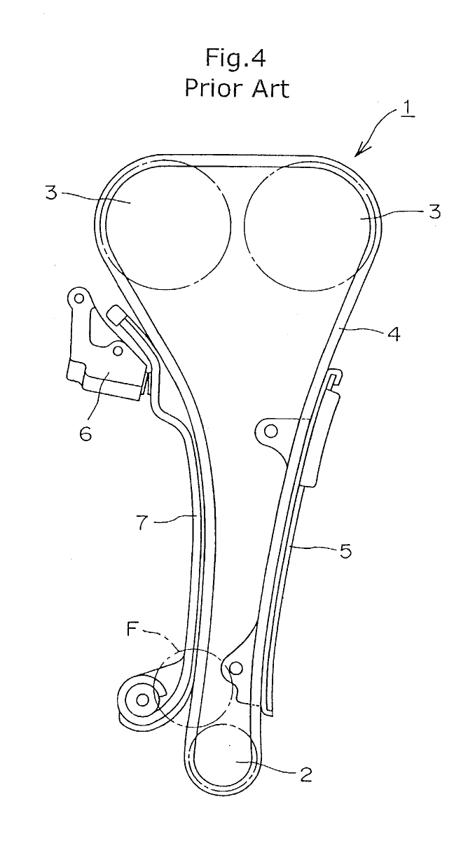

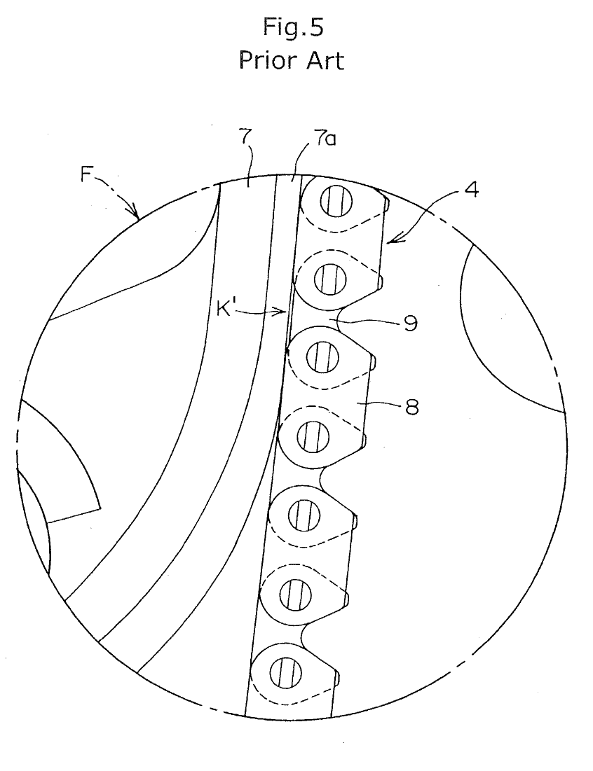

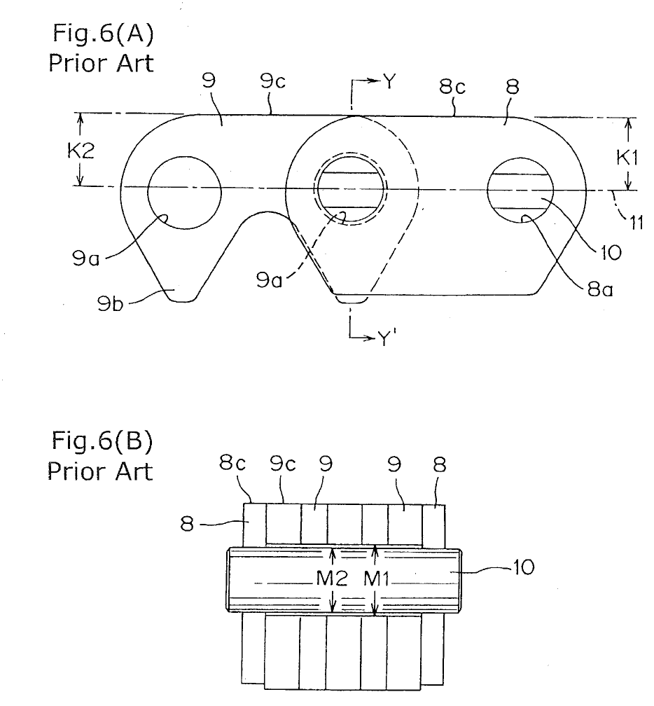

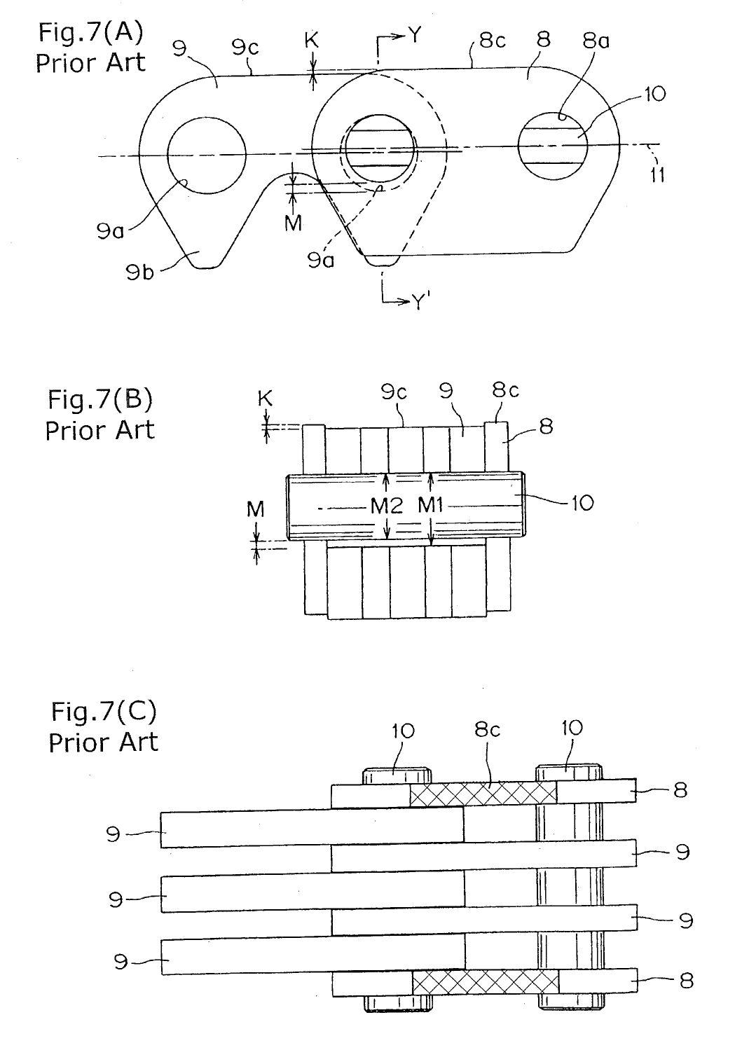

The silent chain 21 of FIGS. 1(A) and 1(B) comprises guide plates 22, each having a pair of pin holes 22a, inner plates 23, each having a pair of pin holes 23a and a pair of teeth 23b for meshing with a sprocket, and connecting pins 24. As shown in FIG. 3(C), the silent chain 21 is formed by interleaving widthwise joint rows, each consisting of laterally spaced toothed plates 23, with widthwise guide rows, each comprising laterally spaced, toothed, inner plates 23 disposed between, and laterally spaced from, a pair of outer guide plates 22, and coupling the rows to each other by means of the connecting pins 24.

The connecting pin 24 is fitted and secured to the pin holes 22a of the guide plates 22, and is fitted into the pin holes 23a of the plates 23 with a clearance. The group of plates constituting the guide row and the group of plates constituting the adjacent joint row are pivoted relative to each other.

In silent chain 21, as shown in FIG. 1(B), the back surfaces 22c of the guide plates 22 are at a position lower than the back surfaces 23c of the inner plate 23 by at least 1/2 of the difference between an inner diameter Q1 of the pin hole 23a of an inner plate 23 and an outer diameter Q2 of the connecting pin 24. Thus, the backs of the guide plates are lower than the backs of the inner plates, that is closer to the pitch line 25, connecting the centers of the pin holes, by a distance Q/2, where Q=Q1−Q2. The pitch line 25 is a straight line connecting the centers of the respective pin holes 22a and 23a of the guide plates and the inner plates, and is horizontal in FIGS. 1(A) and 1(B). In this case, the guide plates 22 and the inner plates 23 are formed so that the backs of the inner plates are higher than the backs of the guide plates by a distance Q/2, when the pin holes are centered on the pitch line.

As shown in FIG. 1(A), if the distance between the back surfaces 22c of the guide plates 22 and the pitch line 25 is P1, and the distance between the back surfaces 23c of the inner plates 23 and the pitch line 25 is P2, the back surfaces 22c of the guide plates 22 are lower than the back surface 23c of the inner plates 23 by a distance P, where P=P2−P1. That is the level P1 of the back surfaces of the guide plates 22 is lower than the level P2 of the back surfaces of the inner plates 23.

In the above explanations, it should be noted that the fact that the back surface 22c of the guide plate 22 is arranged at a position lower than the back surface 23c of the inner plate 23 by at least 1/2 of the difference Q between the inner diameter Q1 of the pin holes 23a of the inner plates 23 and the outer diameter Q2 of the connecting pin 24, means that a level difference P=Q/2 is produced between the back surfaces 22c of the guide plates 22 and the back surfaces of the inner plates 23.

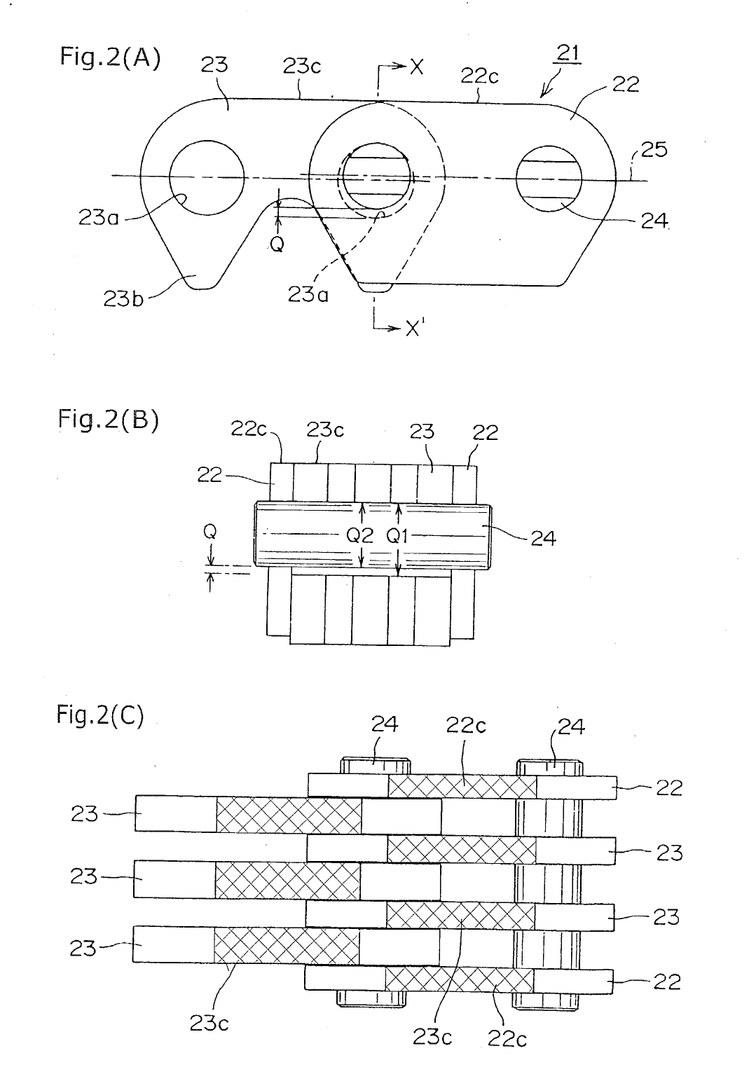

When the silent chain 21 is in sliding contact with a guide (not shown), the inner plates 23 are lowered by the level difference P as shown in FIGS. 2(A) and 2(B). Accordingly, the back surfaces 22c of the guide plate 22 and the back surfaces 23c of the inner plates 23 become substantially flush with each other, so that the back surfaces of all of the plates of the silent chain are in flush relationship. Thus, the contact pressure of the guide is distributed uniformly over the back surfaces 23c of the inner plates 23 and the back surfaces 22c of the guide plates. The portions which make contact with the guide are shown by dotted areas in FIG. 2(C).

As a result, accelerated wear of the edge portions of the guide member, and increasing friction loss, can be prevented, and excessive load applied to the portions of the guide plates at which the connecting pins 24 are secured in pin holes 22a can be suppressed. Accordingly, reduction in the force securing the pins in the pin holes, due to excessive loads at these locations, is avoided, and dislodging of the pins 24 due to a reduction in the securing force is prevented, and breakage of the chain due to dislodgment of the pins can be avoided.

If, when the chain 21 is formed so that the level difference P is greater than Q/2, that is, the level difference satisfies the relationship P>(1/2) Q, when the back surfaces 23c of the inner plates 23 are in sliding contact with a guide, the inner plates 23 are lowered by the pressure exerted by the guide, so that they are related to the guide plates as shown in FIGS. 3(A) and 3(B). The back surfaces 23c of the inner plates 23 become flush with each other, but are higher than the back surfaces 22c of the guide plates 22. Therefore, the guide does not exert pressure on the guide plates 22.

Thus, when the silent chain of FIGS. 3(A)-3(C) is in sliding contact with a guide, the back surfaces of the inner plates 23 uniformly contact the guide, and the surface pressure of the guide is received by the back surfaces 23c of the inner plates 22 as shown in FIG. 3(C). In FIG. 3(C), the portions of the inner plates 23 that contact the guide are shown by dotted areas. In this case, a level difference P3 exists between the back surfaces 23c of the inner plates 23 and the back surfaces 22c of the guide plates 22, as shown in FIG. 2(B).

Here, as in the previously described embodiments, accelerated wear along the opposite edges of the guide, and increased friction loss, are prevented, and dislodgement of the connecting pins, and resulting breakage of the chain, due to excessive load on the guide plates is avoided.

In summary, when the back surfaces of the guide plates are lower than back surfaces of the inner plates by only 1/2 of the difference between the inner diameter of a pin hole of the inner plates and the connecting pins when the centers of the pin holes are on the pitch line, the back surfaces of the guide plates become flush with the back surfaces of the inner plates when the chain is in sliding contact with a guide. In this case, the back surfaces of the inner plates and the guide plates become flush with each other. Alternatively, when back surfaces of the guide plates are positioned lower than back surfaces of the inner plates by more than one-half of the above difference, the back surfaces of the inner plates become flush with each other but are higher than the back surfaces of the guide plates.

Thus, since the entire back surfaces of the silent chain, or the back surfaces of the inner plates, are made flush when the chain is in sliding contact with a guide, the surface pressure between the back surface of the guide plate and the guide is decreased, the fit of the pins in the pin holes of the guide plates is not disturbed by excessive load applied to the guide plates, and breakage of the chain due to a decrease in the fitting force is prevented.

Furthermore, when the entire back surfaces of the inner plates, or all of the plates in a widthwise row of the chain are in flush relationship, level differences on the back surface of the chain can be eliminated, ensuring that the chain will slide smoothly on the guide member.

We claim:

1. A silent chain comprising a guide plate having a back surface and a pair of pin holes, a connecting pin, having an outer diameter, fitted into and secured to one of said pin holes, and a toothed plate having teeth for meshing engagement with a sprocket and also having a back surface and a pair of pin holes each having an inner diameter, the connecting pin fitting into one of the pin holes of the toothed plate with a clearance, wherein, when said guide plate and said toothed plate are arranged so that a pitch line extending through the centers of their respective pin holes is straight, the back surface of said guide plate is closer than the back surface of said toothed plate to the pitch line by at least 1/2 of the difference between the inner diameter of said one of the pin holes of the toothed plate and the outer diameter of said connecting pin.
